(19) United States
(12) Patent Application Publication
(10) Pub. No.: US 2004/0127652 A1
(43) Pub. Date: Jul. 1, 2004

(54) Rubber composition which contains a tack retention additive and tire with component thereof

(76) Inventors: Ramendra Nath Majumdar, Hudson, OH (US); Lewis Timothy Lukich, Akron, OH (US); Bruce Raymond Hahn, Hudson, OH (US); David W. Killian, Cuyahoga Falls, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/330,849

(22) Filed: Dec. 27, 2002

(51) Int. Cl. B60C 1/00; B29D 30/00; B29D 30/06

(52) U.S. Cl. 525/380; 156/128.1; 156/134; 152/565; 156/123

(57) ABSTRACT

The invention relates to a rubber composition which contains an aminoalcohol as a tack retention additive. The invention also relates to a tire having a component of such rubber composition. The invention is further directed to a method of preparing a tire having tire tread ends or other rubber components joined together without an adhesive.

### FIELD

The invention relates to a rubber composition which contains an aminoalcohol, such as triethanolamine, as a tack retention additive and to a tire having a component of such rubber composition. The invention is further directed to a method for adhering rubber components together in a product such as a tire using such a rubber composition wherein the tack retention additive assures adequate building tack such that additional adhesives or cements are not required.

### BACKGROUND

A rubber product, such as a tire, is often manufactured from several pieces of vulcanizable rubber compound, commonly referred to as green rubber. The green rubber is typically formed from a polymer, filler, plasticizer, tackifier, process aids, and a vulcanizing agent. The pieces of green rubber are typically pressed together and then inserted into a mold. In the mold, the pieces of green rubber are subjected to heat and pressure to effect curing and formation of the tire. A tackifier is generally included in the green rubber in order to increase the adherence of the pieces of green rubber to each other, i.e., to increase their tack. If there is insufficient tack between laminated layers of green rubber, tire building may be impossible.

Rubber tires are often prepared in a manufacturing process b y first building a tire carcass and then building a tire tread thereover. The tire tread is conventionally applied to the tire carcass as a relatively flat, wide, sometimes somewhat contoured, uncured rubber strip which is wound around the carcass with the ends of the uncured rubber strip meeting to form a splice. Tread for retreading is often cut at a 90° angle. The ends of the rubber tread strip for a new tire are usually skived, or cut preferably at a low angle, so that higher surface area of the spliced ends overlap each other. Such procedural constructions are well known to those having skill in such art.

Generally it is desired that the uncured rubber tread strip has a degree of tackiness, sometimes referred to as building tack, so that the tread splice holds together after its construction and is suitable for the subsequent tire cure step. However, the uncured tread strip often does not have sufficient natural building tack for such purpose. Furthermore, a rubber component may not be used immediately and may exhibit a significant decrease in tack with time due to blooming or other factors.

Tack of uncured rubber components, particularly treads, is an important property for building rubber articles, such as tires. The term “tack” as used herein refers to the ability of two uncured rubber materials or surfaces to resist separation after bringing them into contact for a short time under relatively light pressure. It is important that uncured components, such as those in a tire, especially the tread, exhibit tack so that rubber components can be securely adhered and so that splices resist separation prior to vulcanization. “Building tack” in the manufacture of tires, holds the inner-liner, beads, plies, sidewalls and tread together prior to vulcanization.

Lack of sufficient tack in uncured rubber components, especially treads, has been an ongoing problem. For many decades, industry has applied cements and/or solvents to uncured rubber components in order to increase their tack. By improving the tack retention of the rubber compounds, the need for additional adhesive compositions can be eliminated, thereby reducing cost.

Examples of these cements and/or solvents are disclosed in U.S. Pat. No. 3,335,041, which issued on Aug. 8, 1967, to Alan Paul Osborne. Osborne discloses an adhesive compound that is applied as a coating to one end of a tread splice prior to joining the two ends of the splice together. U.S. Pat. No. 4,808,657, which issued on Feb. 28, 1989, to Robert J. Brown, discloses a rubbery adhesive cement that is useful to enhance the tack of rubber compounds useful to make treads.

U.S. Pat. No. 4,539,365, which issued to Chong-Kon Rhee on Sep. 3, 1985, discloses a universal cement useful for both synthetic and natural rubber compounds. U.S. Pat. No. 4,497,927, which issued to Tai et al. on Feb. 5, 1985, discloses a solvent-based tire tread adhesive which provides increased green tack and rapid drying.

Efforts have been made to increase the tack of uncured undertread compounds without use of a cement and/or solvent. For example, U.S. Pat. No. 4,647,328 to Chong-Kon Rhee, which issued on Mar. 3, 1987, discloses a process for making belted tires without the use of an undertread cement. Rhee discloses use of a mixture containing p-t-alkylphenol-formaldehyde tackifying resin, a trimethyl-dihydroquinoline polymer and a N,N′-disubstituted phenylenediamine in the undertread compound. Rhee also discloses that tread rubber should be processed in a manner that maintains the rubber at a lower temperature to prevent melting of zinc stearate in the compound and its migration or diffusion to the surface of the undertread.

U.S. Statutory Invention Registration No. H1,871, to Majumdar, published Oct. 3, 2000, discloses curable rubber compounds having enhanced tack. The disclosed compounds contain waxes in amounts less than or equal to their solubility in the compounds to prevent wax bleeding which tends to reduce tack. After green tire is built, melted wax is sprayed which penetrates into tread during cure thus giving the necessary ozone protection

U.S. Pat. No.4,400,485, which issued Aug. 23, 1983, to Mukamal et al. discloses rubber compositions containing a phyllosilicate mineral filler and an amine, such as triethanolamine. The amine appears to be complexed with the phyllosilicate mineral filler particles to provide a synergistic improvement in mechanical properties of the rubber composition.

U.S. Pat. No. 5,218,025, which issued Jun. 8, 1993, to Kurimoto et al. discloses rubber filled with an inorganic white filler such as carbon white and a dinitrodiamine compound. Kurimoto et al. further disclose that an anti-adsorbent, such as triethanolamine, may be added to the composition to moderate the retardation in vulcanization associated with the white filler absorbing the vulcanization accelerator. White fillers described as being useful are those fillers having a silanol group on their surface, namely silica, talc and clay.

Based upon the foregoing, there is a need in the art for rubber compounds that exhibit enhanced initial and long-term tack to insure splice integrity of rubber components, without the need for cements, and to insure structural integrity of uncured rubber articles. The present invention is directed to such rubber compounds. Furthermore, the aminoalcohol in the rubber compositions provides rubber compounds characterized by reduced undesirable side-effects, such as mold fouling.

### SUMMARY OF THE INVENTION

The present invention is directed to curable rubber compounds which exhibit enhanced tack. Compounds of the invention contain a tack retention additive comprising an aminoalcohol which prevents or minimizes the decrease in tack typically observed with uncured rubber compounds with time. By enhanced tack, it is meant that the tack of an uncured rubber compound of the invention is greater than the tack of an uncured rubber compound without the aminoalcohol. Enhanced tack, as referred to herein, can be with respect to either initial tack, long term (aged) tack or both. The improvement in tack is particularly evident with respect to aged tack. Accordingly, the vulcanizable rubber compound of the invention is characterized by good initial tack and retention of tack with time. Furthermore, the rubber compound of the invention also exhibits anti-mold fouling characteristics.

In the description of this invention, the term “phr,” where used herein, and according to conventional practice, refers to “parts of a respective material per 100 parts by weight of rubber or elastomer”.

In the description of this invention, the terms “rubber” and “elastomer,” if used herein, may be used interchangeably, unless otherwise prescribed. The terms “rubber composition,” “compounded rubber” and “rubber compound,” if used herein, are used interchangeably to refer to “rubber which has been blended or mixed with various ingredients and materials” and such terms are well known to those having skill in the rubber mixing or rubber compounding art.

In accordance with one aspect of the present invention, a rubber composition comprising (A) 100 parts by weight of a sulfur vulcanizable elastomer selected from the group consisting of natural rubbers, synthetic rubber and mixtures thereof and (B) about 0.05 to about 5% of an aminoalcohol based on weight of the rubber composition is described wherein the rubber composition has an initial tack of at least about 3N and an aged tack of at least about 50% of the initial tack.

In further accordance with this invention, a tire having a component, particularly a tread or sidewall, of such rubber composition is provided.

In accordance with another aspect of the invention, a method for adhering a first rubber component to itself or to another, second, rubber component without an adhesive is disclosed. The method involves providing a first rubber component comprising (A) 100 parts by weight of a sulfur vulcanizable elastomer and (B) about 0.05 to about 5% of an aminoalcohol; and contacting a first surface of the first rubber component to a second surface of the first rubber component or to a second rubber component to form an adhered article. More particularly, the method may be used to join opposite ends of a tire tread positioned around an uncured tire carcass or a cured tire carcass.

In accordance with yet another embodiment of the invention, a method for improving tack retention in an uncured, sulfur vulcanizable elastomer is provided. The disclosed method includes dispersing an aminoalcohol in a sulfur vulcanizable elastomer to obtain a rubber composition having an initial tack of at least about 3N and an aged tack of at least about 50% of the initial tack.

### DETAILED DESCRIPTION

The present invention is directed to rubber compounds having improved tack retention and methods of producing rubber compositions having improved tack retention. Tire components made from compounds of the invention do not require a solvent or cement to insure adequate green tack. Uncured rubber compounds of the invention have an initial tack of at least about 3 Newtons, preferably at least about 5 Newtons and retain on aging at least about 50%, preferably at least about 80%, more preferably at least about 90%, of the initial tack. The term “aged tack” as used herein refers to tack measured in accordance with the TACK test described below after 7 days of exposure of the rubber sample to air at room temperature.

The aminoalcohol which can be used as a tack retention additive in the rubber composition of the present invention is at least one selected from the group consisting of monoethanolamine, diethanolamine, triethanolamine, N-methylethanolamine, N,N-dimethylethanolamine, N,N-dibutylethanolamine, N,N-diethylethanolamine, N-methyldiethanolamine, 2-amino-2-methylpropanol, 3-aminopropanol and 2-aminopropanol. The preferable aminoalcohol comprises triethanolamine. The aminoalcohols may be used singly or in a combination of two or more thereof. The aminoalcohol is typically added to the rubber composition in an amount of from 0.05-5, more preferably 0.25-2.5% aminoalcohol based on weight of the rubber composition.

Use of the aminoalcohol improves the tack retention of “elastomers or rubbers” before they are cured. The term “elastomer or rubber” as used herein embraces both vulcanized and unvulcanized forms of natural and all its various raw and reclaim forms as well as various synthetic rubbers. The synthetic elastomers include conjugated diene homopolymers and copolymers and copolymers of at least one conjugated diene and aromatic vinyl compound. Representative synthetic polymers include the homopolymerization products of butadiene and its homologues and derivatives, as for example, methyl-butadiene, dimethylbutadiene and pentadiene as well as copolymers, such as those formed from butadiene or its homologues or derivatives with other unsaturated organic compounds. Among the latter are acetylenes, for example, vinyl acetylene; olefins, for example, isobutylene, which copolymerizes with isoprene to form butyl rubber; vinyl compounds, for example, acrylic acid, acrylonitrile (which polymerizes with butadiene to form NBR), methacrylic acid and styrene, the latter polymerizing with butadiene to form SBR, as well as vinyl esters and various unsaturated aldehydes, ketones and ethers, e.g. acrolein, methyl isopropenyl ketone and vinylethyl ether. Also included are the various synthetic rubbers prepared by the homopolymerization of isoprene and the copolymerization of isoprene and other diolefins in various unsaturated organic compounds. Also included are the synthetic rubbers such as 1,4-cis-polybutadiene and 1,4-cis-polyisoprene and similar synthetic rubbers.

Specific examples of synthetic rubbers include neoprene (polychloroprene), polybutadiene (including trans- and cis-1,4-polybutadiene), polyisoprene (including cis-1,4-polyisoprene), butyl rubber, copolymers of 1,3-butadiene or isoprene with monomers such as styrene, acrylonitrile and methyl methacrylate as well as ethylene/propylene terpolymers, also known as ethylene/propylene/diene monomer (EPDM) and, in particular, ethylene/propylene/dicyclopentadiene terpolymers and styrene/isoprene/butadiene rubber. The preferred synthetic rubbers for use in the present invention are polybutadiene, polyisobutylene, butadiene-styrene copolymers and cis-1,4-polyisoprene.

In addition to the aminoalcohol, other rubber additives may also be incorporated in the rubber compound. The additives commonly used in rubber vulcanizates are, for example, carbon black, tackifier resins, processing aids, antioxidants, antiozonants, stearic acid, activators, waxes, phenol-formaldehyde resins, oils and peptizing agents. As known to those skilled in the art, depending on the intended use of the rubber compound, certain additives mentioned above are commonly used in conventional amounts. Typical additions of carbon black comprise about 20 to 100 parts by weight per 100 parts by weight of rubber (phr), preferably 30 to 80 phr. Typical amounts of tackifier resins comprise about 1 to 5 phr. Typical amounts of antioxidants comprise 1 to about 10 phr. Typical amounts of antiozonants comprise 1 to about 10 phr. Typical amounts of stearic acid comprise 1 to about 2 phr. Typical amounts of zinc oxide comprise 2 to 5 phr. Typical amounts of waxes comprise 1 to 5 phr. Typical amounts of phenol-formaldehyde resins comprise 1 to 8 phr. Typical amounts of oils comprise 5 to 40 phr. Typical amounts of peptizers comprise 0.1 to 1 phr. The presence and relative amounts of the above additives are not an aspect of the present invention.

The rubber composition may contain a silica filler. The silica filler may be added in amounts ranging from 10 to 250 phr. Preferably, the silica is present in an amount ranging from 15 to 80 phr. The commonly employed particulate precipitated silica used in rubber compounding applications can be used as the silica in this invention. These precipitated silicas include, for example, those obtained by the acidification of a soluble silicate, e.g., sodium silicate.

The vulcanization of the rubber compound is conducted in the presence of a sulfur-vulcanizing agent. Examples of suitable sulfur-vulcanizing agents include elemental sulfur (free sulfur) or sulfur donating vulcanizing agents, for example, an amine disulfide, polymeric polysulfide or sulfur olefin adducts. Preferably, the sulfur-vulcanizing agent is elemental sulfur. As known to those skilled in the art, sulfur-vulcanizing agents are used in an amount ranging from about 0.5 to 8 phr with a range of from 1.0 to 2.25 being preferred.

Accelerators are conventionally used to control the time and/or temperature required for vulcanization and to improve the properties of the vulcanizate. In some instances, a single accelerator system may be used, i.e., primary accelerator. Conventionally, a primary accelerator is used in amounts ranging from about 0.5 to 2.0 phr. In another instance, combinations of two or more accelerators may be used which may consist of a primary accelerator which is generally used in the large amount (0.5 to 2.0 phr), and a secondary accelerator which is generally used in smaller amounts (0.01-0.50 phr) in order to activate and to improve the properties of the vulcanizate. Combinations of these accelerators have been known to produce a synergistic effect of the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used include amines, disulfides, guanidines, thiophthalimides, thioureas, thiazoles, thiurams, sulfenamides, dithiocarbamates and xanthates. Preferably, the primary accelerator is a sulfenamide. If a secondary accelerator is used, the secondary accelerator is preferably a guanidine, dithiocarbamate or thiuram compound.

The rubber compound may also contain a cure activator. A representative cure activator is methyl trialkyl (C₈-C₁₀) ammonium chloride, commercially available under the trademark Adogen from Sherex Chemical of Dublin, Ohio. The amount of activator may range from 0.05 phr to 5 phr.

The mixing of the rubber composition can be accomplished by methods known to those having skill in the rubber mixing art. For example the ingredients are typically mixed in at least two stages, namely at least one non-productive stage followed by a productive mix stage. The final curatives including sulfur vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The rubber, silica, aminoalcohol and carbon black, if used, are mixed in one or more non-productive mix stages. The terms “non-productive” and “productive” mix stages are well known to those having skill in the rubber mixing art. The rubber composition containing the aminoalcohol and vulcanizable rubber may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

Vulcanization of the rubber compound of the present invention is generally carried out at conventional temperatures ranging from about 100° C. and 200° C. Preferably, the vulcanization is conducted at temperatures ranging from about 110° C. to 180° C. Any of the usual vulcanization processes may be used such as heating in a press or mold, heating with superheated steam or hot air or in a salt bath.

In accordance with another aspect of the invention, a method of preparing a pneumatic rubber tire is provided which comprises building an outer unvulcanized rubber carcass, joining the ends of a tread strip and vulcanizing the resulting assembly under conditions of heat and pressure, wherein the tread strip comprises the rubber composition of the present invention containing an aminoalcohol. The tread strip ends are pressed together without an adhesive to join the tread strip ends prior to vulcanization. The rubber compositions disclosed herein may also be used to adhere the tread (cured or uncured) to a tire casing or to secure any tire component to another tire component.

It is to be appreciated that the preparation of the tire carcass, application or building of the tread onto the carcass and the vulcanizing, or curing, of the assembly in a suitable mold under conditions of pressure and elevated temperature are well known to those having skill in such art.

The rubber compounds containing the aminoalcohols may be used in the preparation of and, therefore, in the form of composite products including tires, power belts, conveyor belts, printing rolls, rubber shoe heels and soles, rubber wringers, automobile floor mats, mud flaps for trucks, ball mill liners, and the like. Preferably, the rubber vulcanizates are used in sidewall, tread, carcass ply, wirecoat or overlay compounds for tires.

The invention may be better understood by reference to the following examples in which the parts and percentages are by weight unless otherwise indicated.

A standard passenger tire sidewall rubber compound (RC) with following formula was prepared:

| | A (phr) |
|---|---|
| Bud ® 1207 from Goodyear | 60 |
| Natural rubber | 40 |
| Carbon black | 51 |
| Phenol formaldehyde resin | 3.5 |
| Zinc oxide | 3.0 |
| Waxes | 1.0 |
| Stabilizers | 5.51 |
| Fatty acid | 1.00 |
| Curatives | 2.64 |
| Oil | 13.25 |
| TOTAL | 180.9 |

Three rubber compounds were prepared with the following compositions. Triethanolamine was dispersed in the tire sidewall compound (RC) using a two-roll mixer.

Sample A 2840 g of passenger tire sidewall compound (RC) (Control).

Sample B 2840 g of passenger tire sidewall compound (RC) and 7.1 g of triethanolamine (0.25%).

Sample C 2840 g of passenger tire sidewall compound (RC) and 71 g of triethanolamine (2.5%).

Property Measurements

Original and aged tack after 7 days of exposure were measured and are shown in Table 1. Fatigue to failure were measured up to 1440 cycles and all three remained as original after the test.

TABLE 1
Effect of Triethanolamine Addition on Fresh and Aged Tack

| Sample | Compound | Fresh Tack (N) | Aged Tack (N) |
|---|---|---|---|
| A | RC (Control) | 6.0 | 1.1 |
| B | RC + 0.25% triethanolamine | 6.5 | 7.1 |
| C | RC + 2.5% triethanolamine | 6.9 | 6.2 |

Sample Preparation for Mold Fouling

Strips of samples A, B and C were rolled in cloth and were tested in a Mold Fouling Simulator. Amounts of materials retained by the mold at 116-220 cures were determined and the calculated amount captured per cure are shown in Table 2.

TABLE 2
Effect of Triethanolamine on Mold Fouling

| | | | % Reduction |
|---|---|---|---|
| | | Mold Fouling | in Mold |
| Sample | Compound | (mg/cure) | Fouling |
| A | RC (Control) | 0.055 | — |
| B | RC + 0.25% triethanolamine | 0.037 | 33 |
| C | RC + 2.5% triethanolamine | 0.031 | 44 |

Effect of triethanolamine on other properties like adhesion, dynamic ozone, modulus, rebound etc. are shown in Tables 3 and 4.

TABLE 3
Effect of Triethanolamine on Compound Properties

| | | | Delta | Adhe- | |
|---|---|---|---|---|---|
| Sam- | | T′90 | Torque | sion | |
| ple | Compound | (minutes) | (dNm) | (N) | Dynamic Ozone |
| A | RC (Control) | 17.3 | 6.4 | 198 | Some Big cracks |
| | | | | | Oil Bloom |
| B | RC + 0.25% | 15.8 | 6.2 | 262* | Many small cracks |
| | triethanol- | | | | No oil bloom |
| | amine | | | | |
| C | RC + 2.5% | 4.4 | 3.8 | 245* | Some small cracks |
| | triethanol- | | | | No oil bloom |
| | amine | | | | |

*Slipped

TABLE 4
Effect of Triethanolamine on Mechanical Properties

| | | 300% | | | |
|---|---|---|---|---|---|
| | | Modulus | El-Brk | Brk Str | Rebound |
| Sample | Compound | (Mpa) | (%) | (Mpa) | 100 C (%) |
| A | RC (Control) | 4.67 | 619 | 13.3 | 60 |
| B | RC + 0.25% | 3.64 | 660 | 12.2 | 54 |
| | triethanolamine | | | | |
| C | RC + 2.5% | 3.90 | 646 | 12.5 | 56 |
| | triethanolamine | | | | |

Table 1 shows that aged tack of the control sample is reduced from 6.0N to 1.1N. In compounds containing 0.25% and 2.5% triethanolamine, no significant deterioration of tack on aging was observed. The mechanism of the aged tack retention with the use of triethanolamine is not yet investigated at this time. Although not wishing to be bound, applicants theorize that triethanolamine could act to block tack inhibiting ingredients blooming to the surface. Thus in dynamic ozone test (see Table 3), oil bloom was prevented in cured pieces. Thus minor oil bloom in uncured state may kill surface tack.

Table 2 clearly demonstrates that mold fouling is also significantly reduced by addition of triethanolamine. By addition of 0.25% trietbanolamine, mold fouling is reduced 33% while by addition of 2.5% triethanolamine mold fouling is reduced by 44%.

Table 3 shows that cured adhesion is significantly improved by addition of triethanolamine. In test samples after dynamic ozone, oil bloom was observed in the control compound and it was not observed in compounds containing triethanolamine. As apparent from delta torque values, low strain modulus is reduced by addition of triethanolamine which can be increased by increasing carbon black loading. Table 3 shows that triethanolamine significantly enhances the cure rate.

The tack measurements were obtained in accordance with the following TACK Test. The TACK Test measures the interfacial tack of two green samples of stock after having been compressed together with a known force. In general, uncured compound is calendered and test samples are built using duplicate precut MYLAR sheets having five evenly-spaced 5 mm wide windows. The top parts of these 5 windows are sloped 45° to a point. The sample is pressed together by an automated apparatus for 30 seconds at 2 atmospheres of pressure. The calendered sample is then cut with a specimen die so that five samples are ready to be pulled on a force displacement tester or equivalent with pneumatic jaws, such as is available from Instron.

Enough of the rubber compound was calendered to obtain one 152.4 mm×304.8 mm×1.27 mm sheet per sample. The sample was tested within 24 hours of calendering, unless aged tack was measured. A piece of masking tape that was 152.4 mm in length was applied along the grain of the calendered stock. The tape was stitched with a 50.8 mm roller or the equivalent using minimum pressure.

Two samples were cut from the calendered sheet using a specimen die. Each sample was 73.0 mm×148.2 mm. The exposed surface was not touched. Two precut 5.0 mm MYLAR sheets were placed on the exposed side of one of the samples. Then the other sample was placed on top of the sheet. The two exposed sides of the samples faced each other with the MYLAR sheets in between. The sample was placed in an Arbor press with a top and bottom pressure plate. A pressure of 2 atmospheres of pressure were applied per sample area.

The sample was removed from the press and centered under a 25.4 mm×88.9 mm cutting die assembly that was attached to a second Arbor press. Enough pressure was applied to cut through the sample, which yielded five specimens.

The test was applied at room temperature (i.e. 25° C.+−1° C. and 55 percent relative humidity). The force displacement tester had the following settings: crosshead speed at 127 mm/min, 25 Newtons for full scale and chart speed at 127 mm/min. The end tabs of one specimen were spread, and it was insured that the only adhesion taking place was under the MYLAR window. The end tabs were clamped in the upper and lower jaws of the tester. The chart was turned on, and the crosshead was engaged. These steps were performed for each of the other four specimens. The chart showed the steady state values of the force to pull the sample apart in Newtons. The tack values shown in the Table herein are the average steady state values for each sample.

The various tests are considered herein to be well known to those having skill in such analytical art.

The addition of the aminoalcohol additive demonstrated a significant improvement in tack retention. Therefore, it is considered herein that a particular benefit of using the aminoalcohol is the increase in aged tack and resistance to fouling it imparts to sulfur cured rubber compositions.

While certain representative embodiments and details have been shown for the purpose of illustrating the invention, it will be apparent to those skilled in this art that various changes and modifications may be made therein without departing from the spirit or scope of the invention.

What is claimed is:

1. A rubber composition comprising (A) 100 parts by weight of a sulfur vulcanizable elastomer selected from the group consisting of natural rubbers, synthetic rubber and mixtures thereof and (B) about 0.05 to about 5% of an aminoalcohol based on weight of the rubber composition wherein said rubber composition has an initial tack of at least about 3N and an aged tack of at least about 50% of said initial tack.

2. The rubber composition of claim 1 wherein said sulfur vulcanizable elastomer is selected from the group consisting of natural rubber, polyisoprene, butyl rubber, polybutadiene, styrene-butadiene copolymer, styrene/isoprene/butadiene rubber, methyl methacrylate-butadiene copolymer, isoprene-styrene copolymer, methyl methacrylate-isoprene copolymer, acrylonitrile-isoprene copolymer, acrylonitrile-butadiene copolymer, EPDM and mixtures thereof.

3. The rubber composition of claim 1 wherein said rubber composition has an initial tack of at least about 5N and an aged tack of at least about 80% of said initial tack.

4. The rubber composition of claim 3 wherein said aged tack is at least about 90% of said initial tack.

5. The rubber composition of claim 1 wherein said aminoalcohol is selected from the group consisting of monoethanolamine, diethanolamine, triethanolamine, N-methylethanolamine, N,N-dimethylethanolamine, N,N-dibutylethanolamine, N,N-diethylethanolamine, N-methyldiethanolamine, 2-amino-2-methylpropanol, 3-aminopropanol and 2-aminopropanol.

6. The rubber composition of claim 5 wherein said aminoalcohol is triethanolamine.

7. The rubber composition of claim 1 wherein said rubber composition is substantially free of fillers having a silanol group on their surface.

8. A tire having a component of the rubber composition of claim 1.

9. A method for adhering a first rubber component to itself or to another, second, rubber component without an adhesive, said method comprising the steps of:
a) providing a first rubber component comprising (A) 100 parts by weight of a sulfur vulcanizable elastomer selected from the group consisting of natural rubbers, synthetic rubber and mixtures thereof and (B) about 0.05 to about 5% of an aminoalcohol based on weight of the rubber composition; and
b) contacting a first surface of said first rubber component to a second surface of said first rubber component or to a second rubber component to form an adhered article.

10. The method of claim 9 wherein the first rubber component is a tire tread positioned around an uncured tire carcass or a cured tire carcass and opposite ends of the tire tread are joined without an adhesive.

11. The method of claim 9 wherein said aminoalcohol is selected from the group consisting of monoethanolamine, diethanolamine, triethanolamine, N-methylethanolamine, N,N-dimethylethanolamine, N,N-dibutylethanolamine, N,N-diethylethanolamine, N-methyldiethanolamine, 2-amino-2-methylpropanol, 3-aminopropanol and 2-aminopropanol.

12. The method of claim 11 wherein said aminoalcohol is triethanolamine.

13. The method of claim 9 wherein at least one of said first rubber component or said second rubber component is a component for tires selected from the group consisting of sidewalls, treads, carcass plies, wirecoats and overlays.

14. A method for improving tack retention in an uncured, sulfur vulcanizable elastomer, said method comprising the steps of:
a) providing a rubber-based material comprising a sulfur vulcanizable elastomer selected from the group consisting of natural rubbers, synthetic rubber and mixtures thereof; and
b) dispersing from about 0.05 to about 5% of an aminoalcohol based on weight in said rubber-based material, thereby obtaining a rubber composition having an initial tack of at least about 3N and an aged tack of at least about 50% of said initial tack.

15. The method of claim 14 wherein from about 0.25 to about 2.5% of an aminoalcohol is dispersed in said rubber composition.

16. The method of claim 14 wherein said aminoalcohol is selected from the group consisting of monoethanolamine, diethanolamine, triethanolamine, N-methylethanolamine, N,N-dimethylethanolamine, N,N-dibutylethanolamine, N,N-diethylethanolamine, N-methyldiethanolamine, 2-amino-2-methylpropanol, 3-aminopropanol and 2-aminopropanol.

17. The method of claim 14 wherein said aminoalcohol is triethanolamine.

18. The method of claim 14 wherein said sulfur vulcanizable elastomer is selected from the group consisting of natural rubber, polyisoprene, butyl rubber, polybutadiene, styrene-butadiene copolymer, styrene/isoprene/butadiene rubber, methyl methacrylate-butadiene copolymer, isoprene-styrene copolymer, methyl methacrylate-isoprene copolymer, acrylonitrile-isoprene copolymer, acrylonitrile-butadiene copolymer, EPDM and mixtures thereof.

19. The method of claim 14 wherein said rubber composition is substantially free of fillers having a silanol group on their surface.

20. The method of claim 14 wherein said rubber composition has an initial tack of at least about 5N and an aged tack of at least about 90% of said initial tack.
